(19) United States
(12) Patent Application Publication
(10) Pub. No.: US 2008/0266902 A1
(43) Pub. Date: Oct. 30, 2008

(54) BACKLIGHT MODULE

(75) Inventor: Xiaopan ZHENG, Beijing (CN)

Correspondence Address: SHERIDAN ROSS PC, 1560 BROADWAY, SUITE 1200, DENVER, CO, 80202, US

(73) Assignee: BEIJING BOE OPTOELECTRONICS TECHNOLOGY CO., LTD., Beijing (CN)

(21) Appl. No.: 12/061,543

(22) Filed: Apr. 2, 2008

(30) Foreign Application Priority Data
Apr. 25, 2007 (CN) 200710098704.7

(51) Int. Cl. F21V 7/04

(52) U.S. Cl. 362/618

(57) ABSTRACT

A backlight module is provided, which comprises a light guide plate assembly comprising an upper light guide plate and a lower guide plate that are stacked together, at least one light source and a reflection film. The light source is disposed on at least one side of the light guide plate assembly with a light incident surfaces of the light guide plate assembly facing the light source. The reflection film is disposed below the light guide plate assembly.

### FIELD OF THE INVENTION

The present invention relates to a backlight module of a liquid crystal display (LCD).

### BACKGROUND OF THE INVENTION

One of the most important components in a backlight module of a liquid crystal display is a light guide plate. FIG. 1 is a schematic view showing a conventional side-type (edge illustration) backlight module without an optical film(s). As shown in FIG. 1, the basic structure of the conventional backlight module comprises one or more light sources 3, a reflection film 4, a light guide plate 7 and a plurality of optical films (not shown) such as a diffusion film, a prism film and a protection film which can be combined in various ways as necessary. The brightness of the backlight module is typically enhanced by the prism film; however, the prism film is expensive and also suffers from inevitable defects during its operation. For example, the prism film tends to warp when heated, and the prisms thereon tend to be scratched, which gives rise to white dots on the display screen and thus lowers the display quality of the LCD.

The incident surface of the light guide plate is normally formed by a plane, thus when light is incident into the light guide plate, the light efficiency can only reach about 80%. In other words, near 20% of the incident light from the light source 3 is lost even before entering the light guide plate. Furthermore, energy loss approaches 30% in the light path from entering the light guide plate to exiting the light guide plate. The energy loss is caused not only by the absorption of the fluorescent material of the light source 3 and the reflective cover of the light source but also by the absorption of the light guide plate and the reflection film. Therefore, it becomes an important subject in the R&D to improve the light efficiency of the light guide plate.

One of the typical methods to improve the light efficiency of the light guide plate is to form a plurality of microstructures on either the upper surface or both surfaces of the light guide plate similarly as those formed on a prism film by an injection molding process. The backlight module having the light guide plate with the prism-like microstructures is improved in brightness without using the prism film. But such type of the light guide plate is expensive since it is made by the injection molding process, therefore the application thereof is limited.

Furthermore, the surface temperature of the backlight module normally reaches about 35° C. during operation, and the temperature inside the backlight module is even higher, in particular around the light source, so that a temperature differences is established between the light source and the effective light-emitting region of the backlight module, which tends to deform the optical films and the light guide plate to a certain degree.

### SUMMARY OF THE INVENTION

According to an aspect of the present invention, there provided a backlight module comprising a light guide plate assembly comprising an upper light guide plate and a lower guide plate that are stacked together, at least one light source and a reflection film. The at least one light source can be disposed on at least one side of the light guide plate assembly with a light incident surface of the light guide plate assembly facing the light source. The reflection film can be disposed below the light guide plate assembly.

Preferably, the lower surface of the lower guide plate is the lower surface of the light guide plate assembly, opposed to the reflection film, and is constructed with a plurality of concave or convex microstructures thereon.

Preferably, a plurality of light diffusing particles are dispersed in the upper light guide plate. The light diffusing particle can be formed of polymer material.

Furthermore, the light incident surface of the light guide plate assembly can be formed in a structure that is selected from the group consisting of a “V” shape structure, a “U” shape structure, a semicircle shape structure, and an arc shape structure.

Another aspect of the present invention provides a light guiding assembly for a backlight module comprising an upper light guide plate and a lower guide plate that are stacked together.

Since the light diffusing particles in the upper light guide plate can change the direction of the incident light, the light incident into the upper light guide plate can be emitted directly from the upper surface of the light guide plate assembly. The lower surface of the lower light guide plate can also change the direction of the light incident into the lower light guide plate by the concave or convex microstructures such that the light incident into the lower light guide plate can be either directed upward to enter the upper light guide plate or reflected onto the underlying reflection film. Most of the light reflected onto the reflection film can be in turn reflected by the reflection film and transmitted through the upper light guide plate, and then emitted from the upper surface of the light guiding plate assembly. As such, the light efficiency of the light guide plate assembly is greatly improved.

Since the light incident surface of the light guide plate assembly is formed as a bended or curved surface compared with the plane surface in the conventional light guide plate, the light incident direction entering the light guide plate assembly is changed so as to improve the light efficiency of the light guide plate assembly. Furthermore, the space containing the light source is increased accordingly to provide more air volume for better heat dissipation of the backlight module. Therefore, the warping of the light guide plate as well as warping of the optical films is significantly reduced.

In addition, a prism film can be omitted for a backlight module with the light guide plate according to the present embodiment due to the high light efficiency of the light guide plate assembly, thus reducing or even eliminating the defects associated the prism film, such as a poor display quality due to a defective backlight module due to scratching or white dot, etc.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the following detailed description.

### BRIEF DESCRIPTION OF THE DRAWING

The present invention will become more fully understood from the detailed description given hereinafter and the accompanying drawings which are given by way of illustration only, and thus are not limitative of the present invention and wherein:

FIG. 1 is a schematic view showing a conventional side-type backlight module;

FIG. 2 is a schematic view showing a backlight module according to a first embodiment of the invention;

FIG. 3 is a schematic view showing a backlight module according to a second embodiment of the invention; and

FIG. 4 is a schematic view showing a backlight module according to a third embodiment of the invention.

### DESCRIPTION OF THE PREFERRED EMBODIMENTS

### First Embodiment

FIG. 2 is a schematic view showing a backlight module according to a first embodiment of the invention. According to FIG. 2, the backlight module according to the present embodiment comprises at least one light source 3, a light guide plate assembly comprising two light guide plates such as an upper light guide plate 1 and a lower light guide plate 2 that are stacked together, and a reflection film 4 and other optical films as necessary (not shown). The reflection film 4 is disposed below the light guide plate assembly such that the lower surface of the lower light guide plate 2 face the reflection film 4. The light source 3 is disposed on one side or both sides of the light guide plate assembly facing the incident light surface of the light guide plate assembly. The lower surface of the lower light guide plate 2 is constructed with a plurality of concave or convex microstructures 5. Both surfaces of the upper light guide plate 1 may be free of such microstructures, and the upper light guide plate 1 includes a plurality of light-diffusing particles 6 dispersed therein. The light-diffusing particles 6 can be made of polymer materials, for example. The upper surface of the upper light plate 1 is the light emitting surface of the light guide plate assembly. The light incident surfaces of the upper light guide plate 1 and the lower light guide plate 2 constitute the light incident surface of the light guiding assembly.

The upper light guide plate 1 and the lower light guide plate 2 of the light guiding assembly can be made with an acryl resin such as polymethylmethacrylate (PMMA) because of its high light transmittance. The incident surface of the light guide plate assembly may be treated for minimizing the reflection of light. In some cases, in order to increase optical effect, an optical film such as a diffusion sheet may be provided above the light guiding assembly, and a light source reflective cover can be disposed around the light source 3. The light source 3 may be a line light source such as a cold cathode fluorescent lamp (CCFL) or a dot light source such as a light emitting diode (LED).

Since the light diffusing particles 6 in the upper light guide plate 1 can change the direction of the incident light, the light incident into the upper light guide plate 1 can be emitted directly from the upper surface of the light guide plate assembly (as indicated by the arrows in FIG. 2). The lower surface of the lower light guide plate 2 can also change the direction of the light incident into the lower light guide plate 2 by the concave or convex microstructures 5 such that the light incident into the lower light guide plate 2 can be either directed upward to enter the upper light guide plate 1 or reflected onto the underlying reflection film 4. Most of the light reflected onto the reflection film 4 can be in turn reflected by the reflection film 4 and transmitted through the light guide plate assembly, and then emitted from the upper surface of the light guide plate assembly. As such, the light efficiency of the light guide plate assembly is greatly improved.

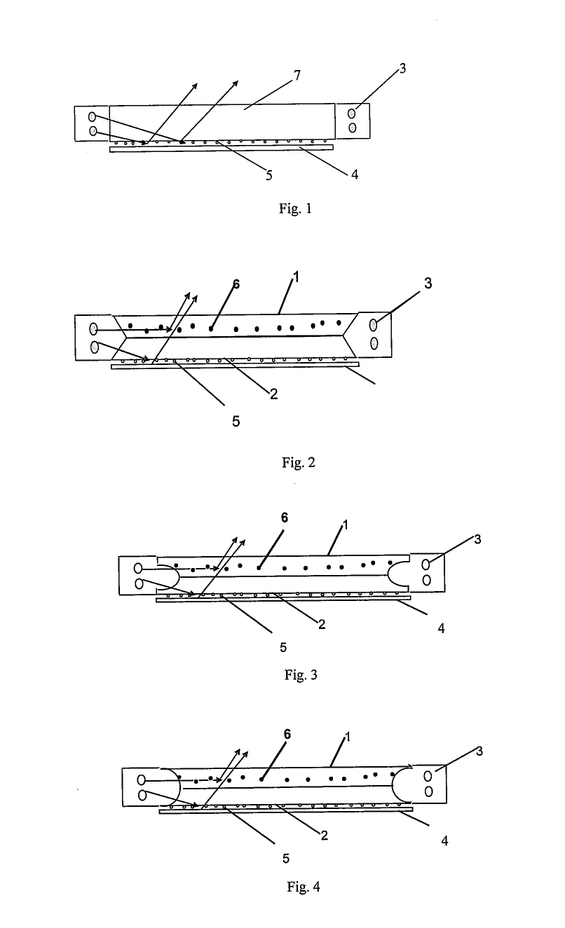

Moreover, the incident surface of the light guide plate assembly comprising the upper light guide plate and the lower light guide plate is not configured as a plane structure perpendicular to the bottom surface of the light guide plate assembly as shown as in FIG. 1 according to a conventional light guide plate. Instead, both incident surfaces of the upper and lower guide plate 1 and 2 are inclined to the bottom or top surface of the light guide plate assembly respectively with the opposite inclined directions and an inclination angle smaller than 90 degree such that the incident surfaces of the two light guide plates are formed as a “V” shape structure.

Since an acute angle is formed between the light incident surface of the upper and lower light guide plates and the top or bottom surface of the light guide assembly compared with the right angle formed in the conventional light guide plate, the light incident direction is changed so as to improve the light efficiency. Furthermore, the space containing the light source such as a lamp chamber enclosed by a reflective cover is increased accordingly to provide more air volume for better heat dissipation of the backlight module. Therefore, the warping of the light guide plate as well as warping of the optical films (if necessary) is significantly reduced.

In addition, a prism film can be omitted for a backlight module with the light guide plate according to the present embodiment due to the high light efficiency of the light guiding plate assembly, thus reducing or even eliminating the defects associated the prism film, such as a poor display quality due to a defective backlight module due to scratching or white dot etc.

### Second Embodiment

FIG. 3 is a schematic view showing a backlight module according to a second embodiment of the invention. As shown in FIG. 3, the light guiding plate according to the present embodiment is substantially the same as the one according to the first embodiment except that the incident surfaces of the lower guiding plate 1 and the lower guide plate 2 are formed as a “U” shape structure. Therefore, the detailed description thereof is not repeated herein.

### Third Embodiment

FIG. 4 is a schematic view showing a backlight module according to a third embodiment of the invention. As shown in FIG. 4, the light guide plate according to the present embodiment is substantially the same as the one according to the first embodiment except that the incident surfaces of the lower guide plate 1 and the lower guide plate 2 are formed as a semi-circle shape structure. Therefore, the detailed description thereof is not repeated herein.

The incident surface of the light guiding assembly can be further changed as necessary, such as an irregular arc shape.

Since the light diffusing particles in the upper light guide plate can change the direction of the incident light, the light incident into the upper light guide plate can be emitted directly from the upper surface of the light guide plate assembly. The lower surface of the lower light guide plate can also change the direction of the light incident into the lower light guide plate by the concave or convex microstructures such that the light incident into the lower light guide plate can be either directed upward to enter the upper light guide plate or reflected onto the underlying reflection film. Most of the light reflected onto the reflection film can be in turn reflected by the reflection film and transmitted through the light guide plate assembly, and then emitted from the upper surface of the light guide plate assembly. As such, the light efficiency of the light guide plate assembly can be greatly improved.

Since the light incident surface of the light guide plate assembly is formed in a “V” shape structure, a “U” shape structure, a semicircle shape structure or other arc shape structure compared with the plane surface in the conventional light guide plate, the light incident direction entering the light guide plate assembly is changed so as to improve the light efficiency of the light guide plate assembly. Furthermore, the space containing the light source is increased accordingly to provide more air volume for better heat dissipation of the backlight module. Therefore, the warping of the light guide plate as well as warping of the optical films is significantly reduced.

In addition, the prism film can be omitted for a backlight module with the light guide plate according to the present embodiment due to the high light efficiency of the light guide plate assembly, thus reducing or even eliminating the defects associated the prism film, such as poor display quality due to a defective backlight module due to scratching or white dot, etc.

The invention being thus described, it will be obvious that the same may be varied in many ways. Such variations are not to be regarded as a departure from the spirit and scope of the invention, and all such modifications as would be obvious to those skilled in the art are intended to be included within the scope of the following claims.

What is claimed is:

1. A backlight module comprising,
a light guide plate assembly comprising an upper light guide plate and a lower guide plate that are stacked together;
at least one light source disposed on at least one side of the light guide plate assembly with a light incident surface of the light guide plate assembly facing the light source; and
a reflection film disposed below the light guide plate assembly.

2. The backlight module according to claim 1, wherein a lower surface of the lower guide plate is the lower surface of the light guide plate assembly, opposed to the reflection film and is constructed with a plurality of concave or convex microstructures thereon.

3. The backlight module according to claim 1, wherein a plurality of light diffusing particles are dispersed in the upper light guide plate.

4. The backlight module according to claim 3, wherein the light diffusing particle is formed of polymer material.

5. The backlight module according to claim 1, wherein the light incident surface of the light guide plate assembly is formed in a structure that is selected from the group consisting of a “V” shape structure, a “U” shape structure, a semicircle shape structure, and an arc shape structure.

6. The backlight module according to claim 1, wherein the upper and lower light guide plate are made of an acryl resin.

7. The backlight module according to claim 1, further comprising a diffusion sheet provided over the light guiding assembly.

8. A light guiding assembly for a backlight module comprising an upper light guide plate and a lower guide plate that are stacked together.

9. The light guiding assembly according to claim 8, wherein a lower surface of the lower guide plate is the lower surface of the light guide plate assembly, opposed to the reflection film and is constructed with a plurality of concave or convex microstructures thereon.

10. The light guiding assembly according to claim 8, wherein a plurality of light diffusing particles are dispersed in the upper light guide plate.

11. The light guiding assembly according to claim 10, wherein the light diffusing particle is formed of polymer material.

12. The light guiding assembly according to claim 8, wherein the light incident surface of the light guide plate assembly is formed in a structure that is selected from the group consisting of a “V” shape structure, a “U” shape structure, a semicircle shape structure, and an arc shape structure.

13. The backlight module according to claim 1, wherein the upper and lower light guide plate are made of an acryl resin.
